(19) United States
(12) Patent Application Publication
(10) Pub. No.: US 2011/0181581 A1
(43) Pub. Date: Jul. 28, 2011

(54) METHOD FOR DRIVING INFORMATION DISPLAY PANEL

(75) Inventors: Takumi Saito, Tokyo (JP); Koji Takao, Tokyo (JP)

(73) Assignee: BRIDGESTONE CORPORATION, Chuo-Ku, Tokyo (JP)

(21) Appl. No.: 12/996,191

(22) PCT Filed: Jun. 4, 2009
(86) PCT No.: PCT/JP2009/060259

§ 371 Date: Mar. 11, 2011

(30) Foreign Application Priority Data
Jun. 6, 2008 (JP) 2008-149058

(51) Int. Cl. G06F 3/038

(52) U.S. Cl. 345/212

(57) ABSTRACT

In a method for driving an information display panel to display information such as an image, in which a display medium comprised of a particle group containing charged particles is sealed between two opposing substrates, at least one of which is transparent; and in which a voltage is applied across opposing pixel electrodes formed such that conductive films provided to the respective substrates are arranged so as to face each other, to drive the display medium, the number of times of application of the pulse voltage applied at the time of rewriting a display is varied according to a filling quantity of the charged particles. In this manner, the method for driving an information display panel can expect improvement of contrast, shortening of time required for drawing, and reduction in electrical power consumption at the time of writing of display at the same time can be provided.

### TECHNICAL FIELD

The present invention relates to a method for driving an information display panel to display information such as an image, which includes sealing a display medium comprised of a particle group containing charged particles between two opposing substrates, at least one of which is transparent, and applying a pulse voltage across opposing pixel electrodes formed such that conductive films are provided to the respective substrates so as to face each other, to drive the charged particles.

### BACKGROUND OF THE INVENTION

Conventionally, various methods are known as a method for driving an information display panel to display information such as an image in which a display medium comprised of a particle group containing charged particles are sealed between two opposing substrates, at least one of which is transparent, and a voltage is applied across opposing pixel electrodes formed by facing conductive films provided to the respective substrates with each other, to drive the charged particles. Of the methods, there has been known a driving method in which a pulse voltage is applied across the electrodes (see, for example, Japanese Patent Application Laid-open No. 2002-82361).

### SUMMARY OF THE INVENTION

### Problems to be Solved by the Invention

According to the conventional driving method utilizing the pulse voltage described above, the number of times of application of pulse voltage is not specified, and hence, and hence, time for drawing one screen increases and electrical power consumption increases as the number of times of application of pulse voltage increases, which proves impractical; on the other hand, contrast deteriorates if the number of times of application of pulse voltage is too small.

An object of the present invention is to solve the problem described above and to provide a method for driving an information display panel that can expect improvement of contrast, shortening of time required for drawing, and reduction in electrical power consumption at the time of writing of a display.

According to the present invention, a method for driving an information display panel to display information, in which a display medium comprised of a particle group containing charged particles is sealed between two opposing substrates, at least one of which is transparent; and, in which a pulse voltage is applied across opposing pixel electrodes formed such that conductive films provided to the respective substrates are arranged so as to face each other, to drive the charged particles, is characterized in that the number of times of application of the pulse voltage applied at the time of rewriting a display is varied according to a filling quantity of the charged particles.

Preferable examples of the method for driving an information display panel according to the present invention include that: the number of times of application of the pulse voltage applied at the time of rewriting the display is varied by using 9.5 g/m² of the filling quantity of the charged particles per unit area in a display-media-arranged area as a threshold value; the pulse voltage is applied 1-2 times when the filling quantity is small, which corresponds to the filling quantity of the charged particles per unit area in a display-media-arranged area being less than 9.5 g/m², and the pulse voltage is applied 12 or more times when the filling quantity is large, which corresponds to the filling quantity of the charged particles exceeding 9.5 g/m²; the number of times of application of the pulse voltage applied at the time of rewriting the display is varied by using 1.0 layer of the charged particles existing on a surface on the side of the respective substrates as a threshold value; the pulse voltage is applied 1-2 times when the filling quantity of the charged particles is small, which corresponds to the layer of the charged particles existing on a surface on the side of the respective substrates being 1.0 layer or lower, and the pulse voltage is applied 12 or more times when the filling quantity of the charged particles is large, which corresponds to the layer of the charged particles existing on a surface on the side of the respective substrates exceeding 1.0 layer; the number of times of application of the pulse voltage applied at the time of rewriting the display is varied by using 20% of volumetric occupation ratio of the charged particles in a space between the panel substrates as a threshold value; and, the pulse voltage is applied 1-2 times when the filling quantity of the charged particles is small, which corresponds to the volumetric occupation ratio of the charged particles in the space between the panel substrates being 20% or lower, and the pulse voltage is applied 12 or more times when the filling quantity of the charged particles is large, which corresponds to the volumetric occupation ratio of the charged particles in the space between the panel substrates exceeding 20%.

According to the present invention, it is possible to obtain a method for driving an information display panel that can expect improvement of contrast, shortening of time required for drawing, reduction in electrical power consumption at the time of rewriting of display and the like at the same time, by varying the number of times of application of a pulse voltage applied at the time of rewriting displays in accordance with the filling quantity of charged particles constituting a display medium. More specifically, the filling quantity of the charged particles and the number of times of application of the pulse voltage are controlled, such that the filling quantity of the charged particles is made large and the number of times of application of the pulse voltage is increased in a case where contrast needs to be more emphasized, and the filling quantity of the charged particles is made small and the number of times of application of the pulse voltage is decreased in a case where reduction in drawing time as well as electrical power consumption at the time of rewriting of a display are more emphasized, whereby the shortening of time required for drawing and the reduction in the electrical power consumption at the time of rewriting displays can be achieved.

### BRIEF DESCRIPTION OF THE DRAWINGS

FIGS. 1(a) and 1(b) are views for explaining one example of an information display panel, to which a method for driving according to the present invention is applied.

FIGS. 2(a) and 2(b) are views for explaining another examples of an information display panel, to which a method for driving according to the present invention is applied.

FIGS. 3(a) and 3(b) are views for explaining one example of pulse voltage applied in a case where white display is performed and a case where black display is performed, respectively.

FIG. 4 is a graph showing a relationship of ratio between the number of times of application of pulse voltage and contrast ratio.

FIG. 5 is a view illustrating examples of shape of a partition wall in a case where a partition wall is used in the information display panel, to which the present invention is applied.

### MODE FOR CARRYING OUT THE INVENTION

First, description will be made of a basic configuration of an information display panel, at which a driving method according to the present invention is targeted. In the information display panel to which the present invention is applied, an electric field is applied to a display medium sealed between two opposing panel substrates and comprised of a particle group containing charged particles. The display medium is attracted along a direction of the applied electric field by a force of the electric field, Coulomb's force and the like, and is moved by change of directions of the electric field, whereby information such as an image is displayed. Therefore, it is necessary for the information display panel to be designed such that the display medium can move uniformly while maintaining stability during repetitive rewrite of a display or continuous display of the display information. The force acting on the particles constituting the display medium may be an attraction force due to Coulomb's force between the particles, an electric image force with respect to the electrodes or substrates, an intermolecular force, a liquid bonding force, gravity and the likes.

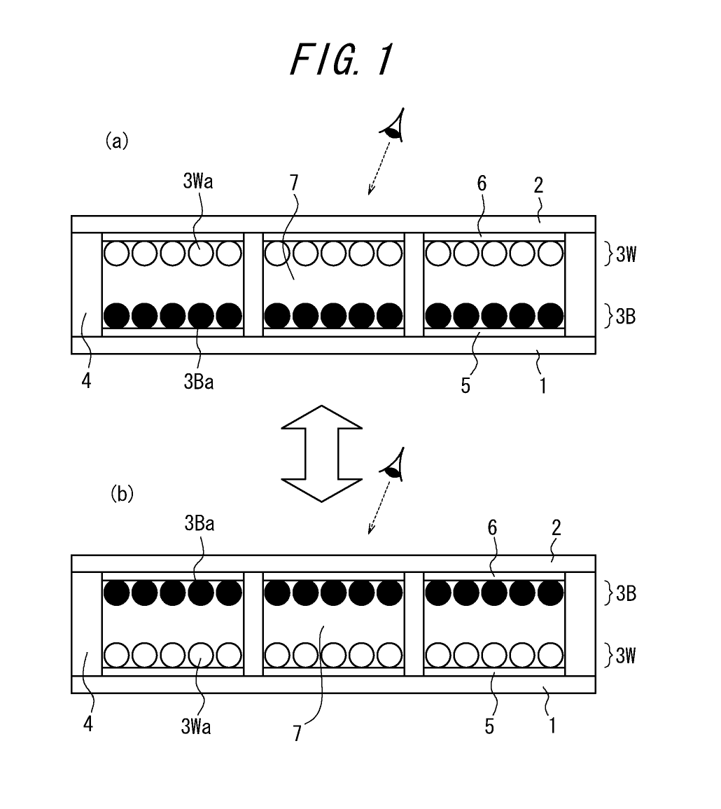

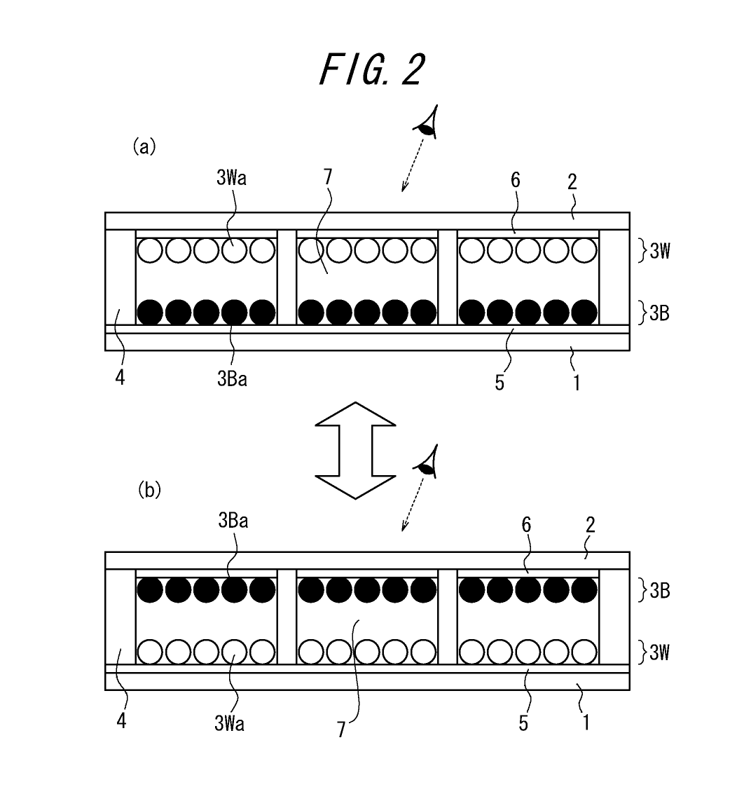

Hereinbelow, examples of the information display panel to which the present invention is applied will be described with reference to FIGS. 1(a)-(b) through FIGS. 2(a)-(b).

In an example illustrated in FIGS. 1(a) and 1(b), at least two types of display media (in this example, a white color display medium 3W comprised of a particle group containing negatively charged white color particles 3Wa and a black color display medium 3B comprised of a particle group containing positively charged black color particles 3Ba are illustrated) comprised of particle groups containing particles having at least an optical reflectivity and an electrification property, which are different between the display medium types, are sealed between substrates 1, 2, and are moved perpendicular to the substrates 1, 2 in each cell 7 formed by a partition wall 4 in accordance with an electric field generated by applying a voltage across an electrode 5 (pixel electrode) provided to the substrate 1 and an electrode 6 (pixel electrode) provided to the substrate 2. Then, a white display is performed so that an observer can visually recognize the white color display medium 3W as illustrated in FIG. 1(a), or a black display is performed so that the observer can visually recognize the black color display medium 3B as illustrated in FIG. 1(b). In this example, a pair of opposing pixel electrodes (1 dot) is arranged in a matrix, so that dot matrix display is performed. Note that, in FIGS. 1(a) and 1(b), a partition wall existing at the frontward side is omitted.

In an example illustrated in FIGS. 2(a) and 2(b), at least two types of display media (in this example, a white color display medium 3W comprised of a particle group containing negatively charged white color particles 3Wa and a black color display medium 3B comprised of a particle group containing positively charged black color particles 3Ba are illustrated) comprised of particle groups containing particles having at least an optical reflectivity and an electrification property, which are different between the display medium types, are sealed between substrates 1, 2, and are moved perpendicular to the substrates 1, 2 in each cell 7 formed by a partition wall 4 in accordance with an electric field generated by applying a voltage across a pair of pixel electrodes formed such that an electrode 5 (line electrode) provided to the substrate 1 and an electrode 6 (line electrode) provided to the substrate 2 face each other and intersect perpendicularly. Then, a white display is performed so that an observer can visually recognize the white color display medium 3W as illustrated in FIG. 2(a), or a black display is performed so that the observer can visually recognize the black color display medium 3B as illustrated in FIG. 2(b). In this example, a pair of opposing pixel electrodes (1 dot) is arranged in a matrix, and dot matrix display is performed. Note that, in FIGS. 2(a) and 2(b), a partition wall existing at the frontward side is omitted.

The driving method according to the present invention is characterized in that, in the information display panel having the structure described above, the number of times of application of pulse voltage applied at the time of rewrite of a display is varied according to a filling quantity of the charged particles constituting the display medium. This specification includes two cases, that is, the filling quantity of the charged particles is large, and is small. As one preferable example, by using 9.5 g/m² of the filling quantity of the charged particles per unit area in a display-media-arranged area as a threshold value, it is defined that the filling quantity is small when the filling quantity of the charged particles is 9.5 g/m² or lower, and the filling quantity is large when the filling quantity of the charged particles exceeds 9.5 g/m². Further, as another preferable example, by using 1.0 layer of the charged particles existing on a surface on the substrate side as a threshold value, it is defined that the filling quantity is small when a size of a layer of the charged particles existing on a surface on the substrate side is 1.0 layer or lower, and the filling quantity is large when the size of the layer of the charged particles existing on the surface on the substrate side exceeds 1.0 layer. Then, the number of times of application of the pulse voltage is made larger when the filling quantity is large, as compared with a case where the filling quantity is small. Specifically, the number of times of application of the pulse voltage is 1-2 times when the filling quantity is small, and the number of times of application of the pulse voltage is 12 times or more when the filling quantity is large. As another preferable example, by using 20% of volumetric occupation ratio of the charged particles in a space between the panel substrates as a threshold value, it may be defined that the filling quantity is small when a volumetric occupation ratio of the charged particles in a space between the panel substrates is 20% or lower, and the filling quantity is large when the volumetric occupation ratio of the charged particles in the space between the panel substrates exceeds 20%.

In this specification, the filling quantity (g/m²) of the charged particles per unit area in a display-media-arranged area means the total quantity (g) of the black color charged particles and the white color charged particles filled in the panel per unit area (m²) of the panel substrate. Further, 1.0 layer of the charged particles existing on a surface on the substrate side means that, when the black color charged particles and the white color charged particles filled in the panel are separately aligned on the respective substrates, each color of the charged particles becomes 1.0 layer. Yet further, volumetric occupation ratio (%) of the charged particles in a space between the panel substrates means the total ratio of the filled black color charged particles and the filled white color charged particles with respect to the space in the panel. Then, it can be considered that the state of the charged particles arranged in the panel is equal to the respective threshold values of 9.5 g/m² of the filling quantity of the charged particles per unit area in a display-media-arranged area, 1.0 layer of the charged particles existing on a surface on the substrate side, and 20(%) of volumetric occupation ratio of the charged particles in a space between the panel substrates. The combination of the black color charged particles and the white color charged particles has been described. The color combination is not limited to the combination of black and white, provided that the respective particle groups have the opposite electrification properties, and, it may be possible to employ a combination of colors having good contrast, or even more, to employ a combination of colors not considering the contrast depending on circumstances.

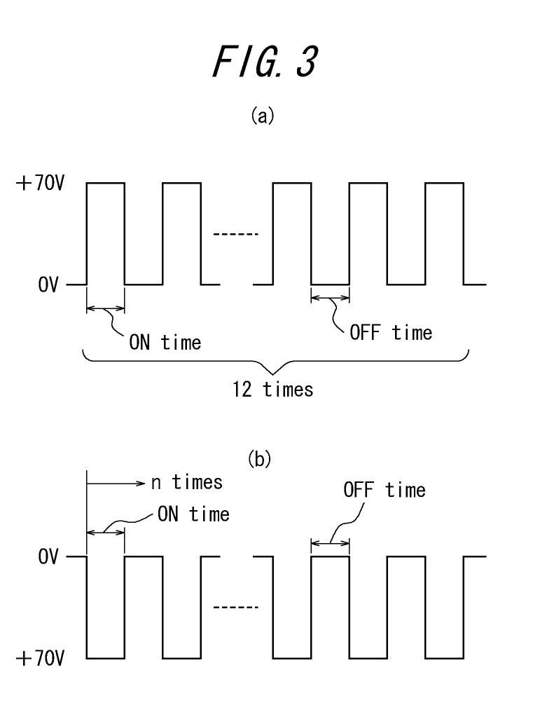

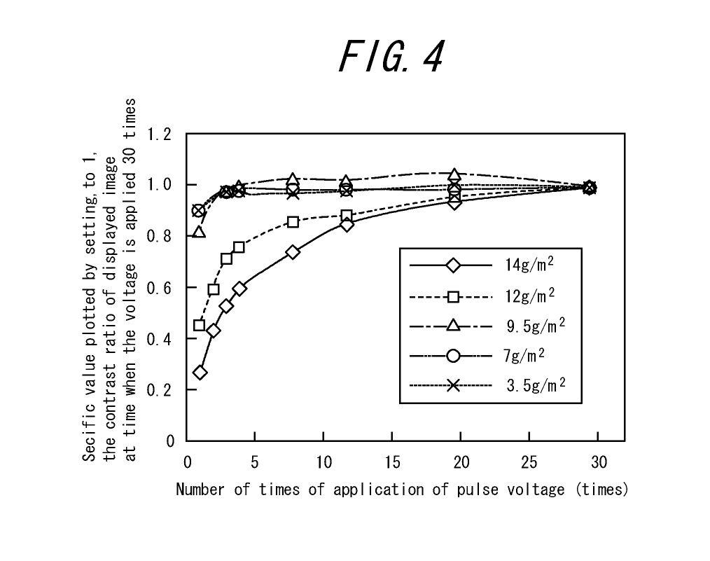

Information display panels are actually manufactured such that black-colored positively charged particles and white-colored negatively charged particles are prepared, and the filling quantity (g/m²) of the charged particles per unit area in a display-media-arranged area, which is obtained as the total quantity, are made varied to be 3.5, 7, 9.5, 12 and 14. For each of the manufactured information display panels, a pulse voltage having a voltage value of +70V is first applied 12 times across the pair of electrodes such that time duration (ON time) for applying the pulse voltage is 500 μs and time duration (OFF time) for not applying the pulse voltage is 500 μs as illustrated in FIG. 3(a), so that white display is performed for the entire screen. Then, as illustrated in FIG. 3(b), a pulse voltage having a voltage value of −70V is applied such that ON time is 500 μs and OFF time is 500 μs, so that black display is performed for the entire screen, and contrast is obtained for each of the numbers of times of application of pulse voltage of 1, 2, 3, 4, 8, 12, 20 and 30 by setting the contrast ratio at the number of times of application of 30 to 1. The thus obtained results are shown in Table 1 below, and on the basis of the results in Table 1, the relationship between the number of times of applied pulse and the proportion of the contrast ratio is shown in FIG. 4. In this specification, the contrast ratio means a contrast ratio=reflectivity of a white color display portion/reflectivity of a black color display portion, and the reflectivity is calculated (reflectivity=10^{-(optical density)}) from optical density measured by an optical densitometer SpectroEye produced by GretagMacbeth Co. Ltd. The proportion of the contrast ratio is calculated by assuming, to be 1, the ratio (contrast ratio) between the reflectivity of the white color display portion and the reflectivity of the black color display portion displayed on the screen by applying the pulse 30 times.

TABLE 1

| Number of | Filling quantity of charged particles | | | | |
|---|---|---|---|---|---|
| times of | (black-colored positively charged particles + | | | | |
| application of | white-colored negatively charged particles) | | | | |
| pulse voltage | 14 (g/m²) | 12 (g/m²) | 9.5 (g/m²) | 7 (g/m²) | 3.5 (g/m²) |
| 1 | 0.27 | 0.45 | 0.82 | 0.90 | 0.90 |
| 2 | 0.43 | 0.59 | 0.95 | 0.95 | 0.95 |
| 3 | 0.52 | 0.72 | 0.98 | 0.95 | 0.98 |
| 4 | 0.60 | 0.76 | 1.00 | 0.99 | 0.97 |
| 8 | 0.74 | 0.86 | 1.03 | 0.98 | 0.97 |
| 12 | 0.86 | 0.89 | 1.02 | 0.98 | 0.98 |
| 20 | 0.94 | 0.96 | 1.05 | 0.99 | 1.00 |
| 30 | 1 | 1 | 1 | 1 | 1 |

From the results in Table 1 and FIG. 4, it is found that a contrast corresponding to 80% or more of the maximum contrast (assuming, to be 1, the contrast ratio at the time when the number of times of application of pulse voltage is 30) can be obtained by applying the pulse one or two times when the filling quantity of the charged particles is small and is 9.5 g/m² or lower. It is also found that the contrast corresponding to 80% or more of the maximum contrast (contrast ratio is 1) can be obtained by applying the pulse 8 times or more, when the filling quantity of the charged particles is large and exceeds 9.5 g/m². From these results, it can be known that it is preferable that the number of times of application of pulse voltage is made larger when the filling quantity of the charged particles per unit area in a display-media-arranged area exceeds 9.5 g/m², as compared with the case where the filling quantity is less than 9.5 g/m². Note that, in addition to rectangle shape illustrated in FIG. 3, it is possible to use a trapezoid or triangle waveform for the pulse voltage, and the ON time corresponds to a time from rise of the pulse voltage to fall of the pulse voltage in the respective waveforms.

Hereinafter, each component constituting the information display panel to which the driving method according to the present invention is applied will be described.

It is preferable that, as the substrate, at least one of the substrates is formed by a transparent substrate through which the display media can be recognized from the outside of the panel, and by a material having high transmissivity to the visible light and favorable heat resistance. The other substrate serving as a rear surface substrate may be either transparent or not transparent. For example, the substrate material includes organic polymeric based substrates such as polyethylene terephthalate (PET), polyethylene naphthalate (PEN), polyethylene (PE), polycarbonate (PC), polyimide (PI), polyether sulfone (PES) and acrylic, glass sheet, quartz sheet, metal sheet and the like, and for the display surface side thereof, the transparent material is selected and used from among the materials described above. It is preferable for a thickness of the substrate to be in a range of 2-2000 μm, and more preferably, in a range of 5-1000 μm. However, when the thickness thereof is too thin, it is difficult to maintain the strength and the uniformity of a distance between the substrates, and on the other hand, when the thickness thereof exceeds 2000 μm, problems occur at the time of making the display panel thin.

Examples of materials forming the electrodes include: metals such as aluminum, silver, nickel, copper and gold; conductive metal oxides such as indium tin oxide (ITO), indium zinc oxide (IZO), aluminum doped zinc oxide (AZO), indium oxide, conductive tin oxide, antimony tin oxide (ATO) and conductive zinc oxide; and conductive polymers such as polyaniline and polypyrrole, polythiophene, and those materials are selected and used depending on applications. Methods of forming the electrodes include: a sputtering method using the materials described above; a vacuum deposition method; a CVD (chemical vacuum deposition) method; a method of forming patterns in a thin-film shape using a coating method and the like; a method of laminating a metal foil (for example, rolled copper foil); and, a method of forming patterns by mixing a conductive material with a solvent or synthetic resin binder and coating it. The electrode provided on the visually recognizing side (display surface side) substrate needs to be transparent, but the electrode provided on the rear surface side substrate is not necessarily to be transparent. In either case, the pattern-formable, conductive materials described above can be preferably used. Note that the thicknesses of the electrodes are determined by considering the conductivity and optical transparency, and are 0.01-10 μm, preferably, 0.05-5 μm. The material and thickness of the electrode provided on the rear surface side needs not to be optically transparent.

A shape of the partition wall provided on the substrate when needed is appropriately determined according to a type of display medium relating to displaying and a shape/arrangement of the electrodes provided, and is not necessarily limited. However, a width of the partition wall is set at 2-100 μm, preferably at 3-50 μm, and a height of the partition wall is set at 10-500 μm, preferably at 10-200 μm. A height of the partition wall disposed for maintaining a gap between the substrates is set so as to correspond to a desired gap between the substrates, such that a top of the partition wall becomes a connection point between the two substrates. It may be possible to set the partition wall disposed for sectioning a space between the substrates into cells so as to have a height same as or lower than the gap between the substrates, and a top portion thereof may be either a connection point or not connection point.

Further, it is considered that the partition wall is formed by a both-rib method of forming a rib on each of the opposing substrates 1, 2 and then connecting them, or by a single-rib method of forming a rib on the single side of the substrates. In this invention, it is possible to employ both of the methods described above.

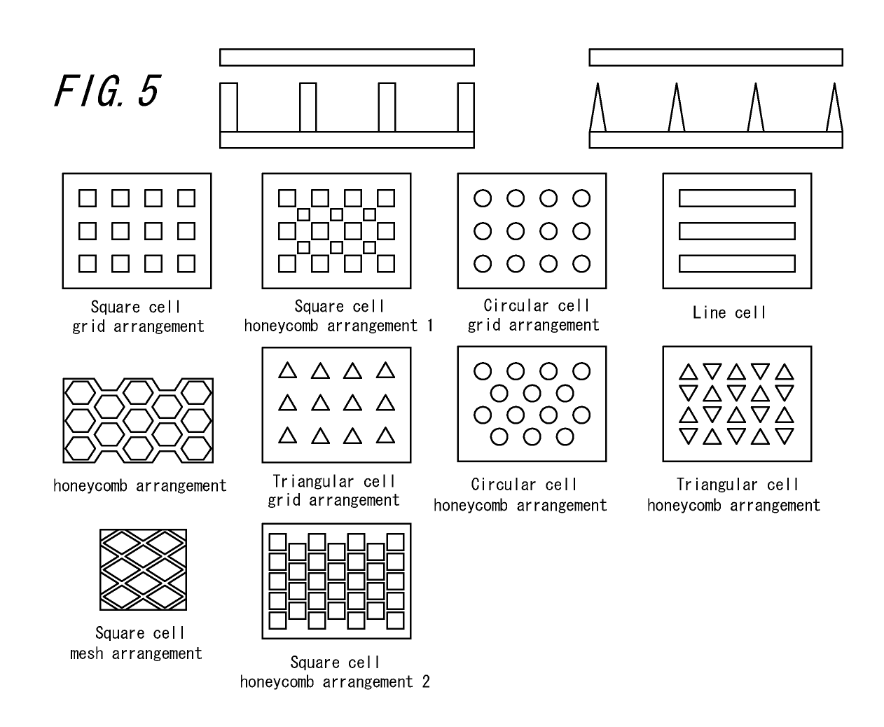

As illustrated in FIG. 5, examples of the cells formed by the partition formed by the rib or the ribs described above include a quadrangle shape, triangle shape, line shape, circle shape and hexagon shape as viewed from the direction of the substrate plane, and examples of arrangement thereof include a lattice arrangement, honey-comb arrangement and network arrangement. It is preferable that a portion (area of frame portion of cell) corresponding to sectional portion of the partition wall visible from the display surface side is set as small as possible, so that sharpness of the displaying state increases.

In this specification, examples of methods of forming the partition wall include a mold transfer method, a screen printing method, a sandblast method, a photolithography method and an additive method. Any of the methods described above may be favorably employed for the information display panel used in the information display device according to the present invention. Of the methods described above, the photolithography method using a resist film or the mold transfer method is preferably employed.

Next, charged particles constituting the display medium of the present invention will be described. As the charged particles used, the particle group contains only the charged particles to form the display medium, or contains mixture of the charged particles and other particles to form the display medium.

The charged particles are formed principally by resins, which may contain a charging control agent, colorant, inorganic additive and the like depending on applications. Examples of the resins, charging control agent, colorant, and other additives will be described below.

Examples of the resins include a urethane resin, urea resin, acrylic resin, polyester resin, acrylic urethane resin, acrylic urethane silicone resin, acrylic urethane fluororesin, acrylic fluororesin, silicone resin, acrylic silicone resin, epoxy resin, polystyrene resin, styrene-acrylic resin, polyolefin resin, butyral resin, vinylidene chloride resin, melamine resin, phenol resin, fluororesin, polycarbonate resin, polysulfone resin, polyether resin, and polyamide resin, and two or more resins may be mixed. In particular, considering control of adhesion strength with the substrate, it is preferable to use the acrylic urethane resin, acrylic silicone resin, acrylic fluororesin, acrylic urethane silicone resin, acrylic urethane fluororesin, fluororesin, and silicone resin.

There is not any particular limitation of the charging control agent, but examples of negative charging control agents include salicylic acid metal complex, metal complex azo dye, metal complex (including metal ion or metal atom) oil-soluble dye, quaternary ammonium salt compound, calixarene compounds, boron containing compound (benzilic acid boron complex), and nitroimidazole derivative. Examples of positive charging control agents include nigrosine dye, triphenylmethane-based compound, quaternary ammonium salt compound, polyamine resin, and imidazole derivative. Additionally, it may be possible to employ ultrafine powder silica; ultrafine powder titanium oxide; metallic oxides such as ultrafine powder alumina; nitrogen containing ring compound such as pyridine and its derivative; and resin containing salt, various kinds of organic pigments, fluorine, chlorine and nitrogen.

As exemplified below, various types and colors of organic and inorganic pigments and dyes may be used as the colorant.

Black colorant includes carbon black, copper oxide, manganese dioxide, aniline black, active carbon and the like.

Blue colorant includes C.I. pigment blue 15:3, C.I. pigment blue 15, iron blue, cobalt blue, alkali blue lake, victoria blue, phthalocyanine blue, metal-free phthalocyanine blue, phthalocyanine blue partial chlorine compound, first sky blue, indanthrene BC and the like.

Red colorant includes colcothar, cadmium red, red lead, mercury sulfide, cadmium, permanent red 4R, lithol red, pyrazolone red, watching red, calcium salt, lake red D, brilliant carmine 6B, eosine lake, rhodamine lake B, alizarin lake, brilliant carmine 3B, C.I. pigment red 2 and the like.

Yellow colorant includes chrome yellow, zinc yellow, cadmium yellow, yellow oxide, mineral first yellow, nickel titanium yellow, navel yellow, naphthol yellow S, hansa yellow G, hansa yellow 10G, benzidine yellow G, benzidine yellow GR, quinoline yellow lake, permanent yellow NCG, tartrazine lake, C.I. pigment yellow 12 and the like

Green colorant includes chrome green, chromium oxide, pigment green B, C.I. pigment green 7, Malachite green lake, final yellow green G and the like.

Orange colorant includes red chrome yellow, molybdenum orange, permanent orange GTR, pyrazolone orange, Balkan orange, indunsren brilliant orange RK, benzidine orange G, Indusren brilliant orange GK, C.I. pigment orange 31 and the like.

Purple colorant includes manganese purple, first violet B, methyl violet lake and the like.

White colorant includes zinc oxide, titanium oxide, antimony white, zinc sulphide and the like.

Extender includes baryta powder, barium carbonate, clay, silica, white carbon, talc, alumina white and the like. Further, as various dyes such as basic dye, acidic dye, dispersion dye, direct dye and the like, there are Nigrosine, Methylene Blue, rose bengal, quinoline yellow, and ultramarine blue.

Examples of inorganic additives include titanium oxide, zinc oxide, zinc sulphide, antimony oxide, calcium carbonate, white lead, talc, silica, calcium silicate, alumina white, cadmium yellow, cadmium red, cadmium orange, titanium yellow, iron blue, ultramarine blue, cobalt blue, cobalt green, cobalt violet, iron oxide, carbon black, manganese ferrite black, cobalt ferrite black, copper powder, aluminum powder and the like.

The pigments and inorganic additives may be used alone or in combination therewith. Particularly, carbon black is preferable as the black pigment, and titanium oxide is preferable as the white pigment. Charged particles having a desired color can be manufactured by mixing the colorants described above.

Further, it is preferable that the charged particle (hereinafter, also referred to as particle) has an average particle diameter d(0.5) ranging from 1 to 20 μm and each of the particles has a uniform size. When the average particle diameter d(0.5) exceeds this range, the image sharpness on the display deteriorates, and, when the average particle diameter is smaller than this range, a cohesive force between the particles becomes too large, possibly inhibiting the movement of the particles as the display medium.

Further, as for the particle diameter distribution, the particle diameter distribution Span, which is defined by the following expression, is less than 5, preferably less than 3.

Span=(d(0.9)−d(0.1))/d(0.5)

(where, d(0.5) indicates a value of the particle diameter expressed by μm in which 50% of the particles have the diameter larger than this value and 50% of the particles have the diameter smaller than this value, d(0.1) indicates a value of the particle diameter expressed by μm in which a percentage of the particles having the diameter smaller than or equal to this value is 10%, and d(0.9) indicates a value of the particle diameter expressed by μm in which a percentage of the particles having the diameter smaller than or equal to this value is 90%.)

By reducing Span to less than or equal to 5, the sizes of the charged particles are made uniform and the charged particles can move as the uniform display medium.

Yet further, when using plural display media, it is important to set a ratio of d(0.5) of charged particles exhibiting the smallest average particle diameter d(0.5) with respect to d(0.5) of charged particles exhibiting the largest average particle diameter d(0.5) to 10 or smaller in the charged particles constituting the respective display media used. Even if the particle diameter distribution Span is made smaller, the particles having different electrification properties with each other are moved in the opposite directions, and hence, it is preferred that the particle sizes are formed closely with each other to make the particles easily moved, which is realized by the above-described range.

It should be noted that the particle diameter distribution and the particle diameter can be obtained with a laser diffraction/scattering method and the like. By irradiating a laser light to the particles to be measured, a light intensity distribution pattern due to a diffraction/scattering light occurs spatially. This light intensity pattern is in the relationship with the particle diameter, and hence, the particle diameter and the particle diameter distribution can be obtained.

The particle diameter and the particle diameter distribution are obtained on the basis of the volume-based distribution. More specifically, by using a measurement unit Mastersizer2000 (Malvern Instruments Ltd.), particles are inserted into a stream of nitrogen to be able to measure the particle diameter and the particle diameter distribution with the attached analysis software (software using a Mie theory and based on the volume-based distribution).

Further, in a case of employing a type in which display media comprised of and containing charged particles are driven in a space filled with gas, it is important to control the gas located in the space and surrounding the display media between the panel substrates, which contributes to improvement of display stability. More specifically, it is important to set a relative humidity of the gas in the space at 60% RH or lower at 25° C., preferably, at 50% RH or lower.

The space described above represents a portion existing between the opposing substrate 1 and substrate 2 in FIGS. 1(a) and 1(b) through FIGS. 2(a) and (b) excluding the electrodes 5, 6 (in a case where the substrates are provided inside of the respective substrates), a portion occupied by the display media 3, a portion occupied by the partition wall 4 (in a case of installing the partition) and a sealing portion of the panels, that is, a gas portion that is in contact with the display media.

Any type can be used as the gas between the spaces described above, provided that humidity thereof falls within the humidity range described above. However, it is preferable to use a dried air, dried nitrogen, dried argon, dried helium, dried carbon dioxide, dried methane and the like. This gas needs to be sealed in the panels so as to maintain the desired humidity, and it is important, for example, to fill the display media, build the panels and implement other processes under a predetermined humidity environment, and then, to apply the seal material and sealing method to prevent the wet from intruding from the outside.

In the information display panel to which the present invention is applied, the gap between the substrates is set such that the display medium can be driven and the contrast can be maintained, and in general, is adjusted in a range of 2-500 μm, preferably of 5-200 μm.

In a case of employing a type where charged particles are moved in the space filled with gas, the gap between the substrates is adjusted in a range of 10-100 μm, preferably of 10-50 μm. Further, it is preferable for the volumetric occupation ratio of the display medium located in the space filled with the gas between the substrates to be 5-70%, more preferably, to be 5-60%. In a case where the volumetric occupation ratio exceeds 70%, problems concerning movement of the particles as the display medium occur, and in a case where the volumetric occupation ratio is less than 5%, the contrast is likely to deteriorate.

### INDUSTRIAL APPLICABILITY

The information display panel according to the present invention is suitable for use as a display device of a mobile device such as a notebook computer, a PDA, a cell phone and a handy terminal; a display device of an electronic paper such as an electronic book, an electronic newspaper and an electronic manual (instruction manual), a message board such as a billboard, poster and blackboard, a calculator, an electrical appliance, an automobile part and the like; a card display unit of a point card, an IC card and the like; a display unit of an electronic advertisement, an electronic POP (point of presence, point of purchase advertizing), an electronic price tag, an electronic price shelf-tag, an electronic music score and a RFID device; and a display device (so-called rewritable paper) that is connected with an external display rewriting means and rewrites displays.

According to the method for driving the information display panel of the present invention, different driving methods are implemented according to the filling quantity of the charged particles, so that: a high contrast can be obtained in a case of advertisement or other cases where more emphasizes are put on the display property, by increasing the filling quantity of the charged particles while controlling so as to increase the number of times of application of the pulse voltage for rewriting the display, which corresponds to erasing images; and, time required for drawing can be shortened in a case of the moving images or other cases where time required for drawing needs to be shortened, by decreasing the filling quantity of the charged particles while controlling so as to decrease the number of times of application of the pulse voltage for rewriting the display, which corresponds to erasing images.

1. A method for driving an information display panel to display information, in which a display medium comprised of a particle group containing charged particles is sealed between two opposing substrates, at least one of which is transparent; and, in which a pulse voltage is applied across opposing pixel electrodes formed such that conductive films provided to the respective substrates are arranged so as to face each other, to drive the charged particles, characterized in that
the number of times of application of the pulse voltage applied at the time of rewriting a display is varied according to a filling quantity of the charged particles.

2. The method for driving an information display panel according to claim 1, wherein the number of times of application of the pulse voltage applied at the time of rewriting the display is varied by using 9.5 g/m² of the filling quantity of the charged particles per unit area in a display-media-arranged area as a threshold value.

3. The method for driving an information display panel according to claim 2, wherein the number of times of application of the pulse voltage is made larger in a case where the filling quantity of the charged particles per unit area in a display-media-arranged area exceeds 9.5 g/m², as compared with a case where the filling quantity is less than 9.5 g/m².

4. The method for driving an information display panel according to claim 1, wherein the number of times of application of the pulse voltage applied at the time of rewriting the display is varied by using 1.0 layer of the charged particles existing on a surface on the side of the respective substrates as a threshold value.

5. The method for driving an information display panel according to claim 4, wherein the pulse voltage is applied 1-2 times when the filling quantity of the charged particles is small, which corresponds to a case where a layer of the charged particles existing on a surface on the side of the respective substrates is 1.0 layer or lower, and the pulse voltage is applied 12 or more times when the filling quantity of the charged particles is large, which corresponds to a case where the layer of the charged particles existing on a surface on the side of the respective substrates exceeds 1.0 layer.

6. The method for driving an information display panel according to claim 1, wherein the number of times of application of the pulse voltage applied at the time of rewriting the display is varied by using 20% of volumetric occupation ratio of the charged particles in a space between the panel substrates as a threshold value.

7. The method for driving an information display panel according to claim 6, wherein the pulse voltage is applied 1-2 times when the filling quantity of the charged particles is small, which corresponds to a case where the volumetric occupation ratio of the charged particles in the space between the panel substrates is 20% or lower, and the pulse voltage is applied 12 or more times when the filling quantity of the charged particles is large, which corresponds to a case where the volumetric occupation ratio of the charged particles in the space between the panel substrates exceeds 20%.
